(19) United States
(12) Patent Application Publication
(10) Pub. No.: US 2026/0244635 A1
(43) Pub. Date: Aug. 20, 2026

(54) METHOD AND APPARATUS FOR QUERYING DATA, DEVICE, AND PRODUCT

(71) Applicant: Beijing Zitiao Network Technology Co., Ltd., Beijing (CN)

(72) Inventors: Jiaxiong YI, Beijing (CN); Zhixing ZENG, Beijing (CN); Xing ZHANG, Beijing (CN)

(21) Appl. No.: 19/540,476

(22) Filed: Feb. 13, 2026

(30) Foreign Application Priority Data
Feb. 14, 2025 (WO) PCT/CN2025/077398

(51) Int. Cl. G06F 16/248; G06F 16/245; G06F 16/9535

(52) U.S. Cl. CPC G06F 16/248; G06F 16/245; G06F 16/9535

(57) ABSTRACT

The present disclosure relates to a method and apparatus for querying data, a device, and a product. The method includes acquiring a first data query initiated by a user. The method further includes acquiring a remaining resource associated with the user. The method further includes determining, based on the remaining resource, that the first data query meets a predetermined security limit. The method further includes generating a second data query by modifying the first data query. Additionally, the method further includes executing the second data query.

### CROSS-REFERENCE TO RELATED APPLICATION(S)

This application claims priority to International Patent Application No. PCT/CN2025/077398 filed in February 14, 2025, the disclosure of which is incorporated herein by reference in its entity.

### FIELD

The present disclosure relates to the field of data security, and more specifically, to a method and apparatus for querying data, a device, and a product.

### BACKGROUND

In the context of rapid information development, people are paying increasing attention to data security, especially in fields involving sensitive information, such as healthcare, finance, social networks, and individual behavior data. In the process of data sharing and usage, how to protect personal privacy while ensuring data availability and research value has become an important problem that urgently needs to be solved.

To solve the problem, differential privacy, as an advanced technology that can quantify the level of data protection, is widely concerned and applied. The differential privacy "dilutes" the impact of individual data on overall statistical results by adding designed random noise to original data, thereby preventing third parties from inferring accurate data associated with specific users by analyzing data query results.

### SUMMARY

In a first aspect of embodiments of the present disclosure, a method for querying data is provided. The method includes acquiring a first data query initiated by a user. The method further includes acquiring a remaining resource associated with the user. The method further includes determining, based on the remaining resource, that the first data query meets a predetermined security limit. The method further includes generating a second data query by modifying the first data query. Additionally, the method further includes executing the second data query.

In a second aspect of the embodiments of the present disclosure, an apparatus for querying data is provided. The apparatus includes a data query acquisition module, configured to acquire a first data query initiated by a user. The apparatus further includes a remaining resource acquisition module, configured to acquire a remaining resource associated with the user. The apparatus further includes a security limit check module, configured to determine, based on the remaining resource, that the first data query meets a predetermined security limit. The apparatus further includes a data query rewriting module, configured to generate a second data query by modifying the first data query. Additionally, the apparatus further includes a data query execution module, configured to execute the second data query.

In a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for querying data. The method includes acquiring a first data query initiated by a user. The method further includes acquiring a remaining resource associated with the user. The method further includes determining, based on the remaining resource, that the first data query meets a predetermined security limit. The method further includes generating a second data query by modifying the first data query. Additionally, the method further includes executing the second data query.

In a fourth aspect of the embodiments of the present disclosure, a computer program product is provided. The computer program product is tangibly stored on a non-transitory computer-readable medium and includes machine-executable instructions, and the machine-executable instructions, when executed, causes a machine to implement a method for querying data. The method includes acquiring a first data query initiated by a user. The method further includes acquiring a remaining resource associated with the user. The method further includes determining, based on the remaining resource, that the first data query meets a predetermined security limit. The method further includes generating a second data query by modifying the first data query. Additionally, the method further includes executing the second data query.

The section SUMMARY is provided to introduce concept selection in a simplified form, which will be further described in the following DETAILED DESCRIPTION OF EMBODIMENTS. The section SUMMARY is not intended to identify key or essential features of the subject claimed for protection, nor is it intended to limit the scope of the subject claimed for protection.

### BRIEF DESCRIPTION OF THE DRAWINGS

The above and other features, advantages, and aspects of various embodiments of the present disclosure will become more apparent in combination with the accompanying drawings and with reference to following detailed descriptions. In the accompanying drawings, the same or similar reference numerals denote the same or similar elements.

FIG. 1 illustrates a schematic diagram of an example environment where a plurality of embodiments of the present disclosure may be implemented;

FIG. 2 illustrates a flowchart of a method for querying data according to some embodiments of the present disclosure;

FIG. 3 illustrates a flowchart of an example process for querying data according to some embodiments of the present disclosure;

FIG. 4 illustrates a schematic diagram of an example of a security module of a differential privacy online system according to some embodiments of the present disclosure;

FIG. 5 illustrates a schematic diagram of an example of a resource consumption determination module of a differential privacy online system according to some embodiments of the present disclosure;

FIG. 6 illustrates a schematic diagram of an example of a resource management module of a differential privacy online system according to some embodiments of the present disclosure;

FIG. 7 illustrates a block diagram of an apparatus for querying data according to some embodiments of the present disclosure; and

FIG. 8 illustrates a block diagram of a device capable of implementing a plurality of embodiments of the present disclosure.

### DETAILED DESCRIPTION OF EMBODIMENTS

It should be understood that all user-related data involved in the technical solution should be acquired and used after user authorization, which means that in the technical solution, if personal information of a user needs to be used, explicit consent and authorization from the user are required before acquiring these data, otherwise, relevant data collection and use will not be carried out. It should also be understood that when the technical solution is implemented, relevant laws and regulations should be strictly followed in the process of data collection, use, and storage, and necessary technologies and measures should be taken to ensure the security of user data and the safe use of the data.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term "include" and similar terms thereof should be understood as open-ended inclusions, namely, "including but not limited to". The term "based on" should be understood as "at least partially based on". The term "an embodiment" or "this embodiment" should be understood as "at least one embodiment". The terms "first", "second", etc. may refer to different or identical objects, unless otherwise explicitly specified. Other explicit and implicit definitions may also be included below.

As mentioned above, the differential privacy "dilutes" the impact of individual data on overall statistical results by adding designed random noise to original data, thereby preventing third parties from inferring accurate data associated with specific users by analyzing data query results. A size of the added noise may depend on a plurality of factors, and these factors may include, for example, a privacy budget, a size of a dataset, and sensitivity of a query. The privacy budget may control the strength of data protection. The smaller the budget, the stronger the data protection, and correspondingly, the data availability will be reduced. Additionally, the size of the added noise may also be influenced by a scale of the dataset. For example, in large-scale data, the impact of individual data is small, and therefore a low noise level may be used. However, in a small-scale dataset, more noise potentially needs to be added to prevent individual data points from being reversely inferred. Additionally, the sensitivity of the query may also affect the size of the added noise. For example, different types of queries (e.g., counting, summing, or averaging) have varying sensitivities to changes in individual data, and therefore when a differential privacy algorithm is designed, adjustment and optimization may be performed for a specific query type.

An existing differential privacy application system still faces multiple challenges in actual deployment and use (especially when dealing with complex business requirements and multiple query scenarios). For example, in some related art, the differential privacy system still relies on manual operation and maintenance, which not only increases management costs but may also introduce errors or security risks from human operations. Additionally, the existing differential privacy system cannot effectively control the volume and speed of data queries and the differential privacy algorithm that the user is allowed to execute. If the user is allowed to execute a large number of data queries, the system may be unable to provide sufficient data protection, thereby increasing the risk of data leakage.

In view of this, an embodiment of the present disclosure provides a solution for querying data. In the solution, a processing device may acquire a data query initiated by a user and a remaining resource associated with the user. Then, the processing device may determine, based on the remaining resource associated with the user, whether the data query meets a predetermined security limit. When the data query meets the predetermined security limit, the processing device may modify the data query. Then, the processing device may execute the modified data query.

Through the method, different resources for executing data queries can be allocated to different users, and only when the remaining resource associated with the user meet the predetermined security limit, the data query executing process may proceed. Then, the processing device may properly modify the data query to protect security of queried data. Therefore, the probability that the user reversely infers the individual data by executing the large number of data queries can be reduced, thereby improving data security.

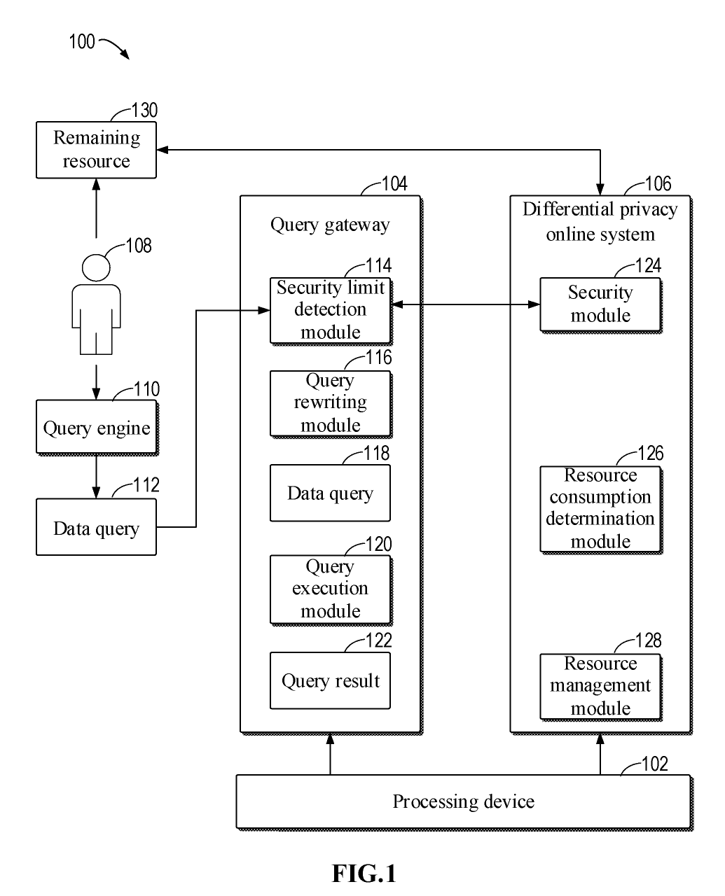

FIG. 1 illustrates a schematic diagram of an example environment 100 where a plurality of embodiments of the present disclosure may be implemented. As shown in FIG. 1, the environment 100 includes a processing device 102.The processing device 102 may be any device with a processing capability or a computing capability. For example, the processing device 102 may be a cloud server, a local server, a virtual server, a desktop computer, a laptop computer, or the like. A query gateway 104 and a differential privacy online system 106 may run on the processing device 102. In some embodiments, the query gateway 104 and the differential privacy online system 106 may run on a plurality of processing devices 102.

In the environment 100, a user 108 may initiate a data query 112 through a query engine 110. For example, the user 108 may be a data analyst, a development engineer, or a business personnel. The user 108 may request data by writing a query statement (or generating a query statement through a user interface). The data query engine 110 is a tool or system for processing and analyzing large-scale data. For example, the data query engine 110 may be a columnar database management system (e.g., ClickHouse), which is suitable for real-time data analysis and large-scale data queries. The data query engine 110 may also be a distributed computing engine (e.g., Spark), which may support various computing modes such as batch processing, stream processing, and machine learning. The data query 112 may be a query statement (e.g., an SQL statement) written in a query language, which is used to retrieve and manipulate data from a database.

In the environment 100, the query gateway 104 includes a security limit detection module 114, a query rewriting module 116, and a query execution module 120. Additionally, the differential privacy online system 106 may include a security module 124, a resource consumption determination module 126, and a resource management module 128. The query gateway 104 may acquire the data query 112 initiated by the user 108. Then, the security limit detection module 114 of the query gateway 104 may communicate with the differential privacy online system 106, to determine whether the data query 112 meets the predetermined security limit.

In the environment 100, to determine whether the data query 112 meets the predetermined security limit, the security module 124 of the differential privacy online system 106 may acquire a remaining resource 130 associated with the user 108. In the environment 100, a resource may indicate a budget allocated to a user or a user group to which the user belongs for querying data. For example, a resource consumed for executing the data query 112 may be 0.05, 0.1, 0.2, etc., and the remaining resource 130 may be 3.5, 10, 50, etc. In some embodiments, the remaining resource 130 associated with the user 108 may be a remaining resource allocated to the user 108. In some embodiments, the remaining resource 130 associated with the user 108 may be a remaining resource allocated to a user group to which the user 108 belongs. In this case, all users in the user group may share the resource allocated to the user group.

In the environment 100, the security module 124 may determine, based on the remaining resource 130, whether the data query 112 meets the predetermined security limit. In some embodiments, the predetermined security limit may include whether the remaining resource associated with the user meets (e.g., are greater than, or greater than or equal to) a predetermined resource threshold (e.g., 0, 0.1, 0.5, and 1). In some embodiments, the predetermined security limit may also include whether the number of historical data queries executed by the current user that are the same as the current data query meets (e.g., is less than, or less than or equal to) a predetermined count threshold. Then, the security module 124 may send a security limit detection result to the query gateway 104. If the detection result indicates that the data query 112 does not meet the predetermined security limit, the query gateway 104 may refuse to execute the data query 112. If the detection result indicates that the data query 112 meets the predetermined security limit, the query gateway 104 may proceed with the execution process of the data query 112.

In the environment 100, after determining that the data query 112 meets the predetermined security limit, the query rewriting module 116 of the query gateway 104 may rewrite the data query 112, thereby generating a rewritten data query 118. For example, the query rewriting module 116 may perform the differential privacy algorithm on the data query 112 to generate the data query 118. In some embodiments, the query rewriting module 116 may acquire pre-determined rewriting strategies, where these rewriting strategies are determined based on a plurality of modes of aggregation query statements. For example, the aggregation query statement is a query that performs summarization and statistics on data, and may include, for example, a sum, an average value, a maximum value, and a minimum value.

In some embodiments, the resource consumption determination module 126 of the differential privacy online system 106 may determine resource consumption corresponding to the data query 112. For example, the resource consumption determination module 126 may respectively determine a plurality of pieces of resource consumption for a plurality of data fields contained in the data query 112, and the plurality of pieces of resource consumption may be determined based on whether the data fields are associated with target data (e.g., user data). Then, the resource consumption determination module 126 may determine total resource consumption of the data query 112 based on the plurality of pieces of resource consumption for the plurality of data fields.

In the environment 100, the query execution module 120 of the query gateway 104 may execute the data query 118 (e.g., by using the query engine 110) to generate a query result 122. Then, the query result 122 may be sent to the user 108 (e.g., displayed to the user 108 through a user interface at a client). Additionally, the resource management module 128 of the differential privacy online system 106 may acquire resource consumption corresponding to the data query 112, that is determined by the resource consumption determination module 126, and update the remaining resource 130 through the resource consumption.

Through the method, a system administrator can allocate different resources for executing data queries to different users, and only when the remaining resource 130 associated with the user 108 meet the predetermined security limit, the execution process of the data query 112 may proceed. Then, the query gateway 104 may protect security of the queried data by rewriting the data query 112. Therefore, the probability that the user 108 reversely infers individual data by executing a large number of data queries can be reduced, thereby improving data security.

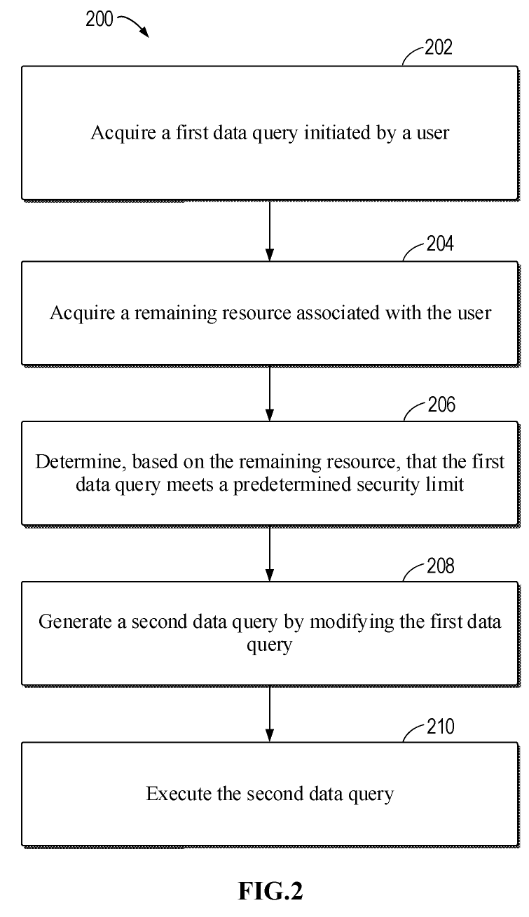

FIG. 2 illustrates a flowchart of a method 200 for querying data according to some embodiments of the present disclosure. The method 200 may be performed by a processing device. For example, the method 200 may be performed by the processing device 102 in FIG. 1. As shown in FIG. 2, at a block 202, the processing device may acquire a first data query initiated by a user. For example, in the environment 100 shown in FIG. 1, the query gateway 104 running on the processing device 102 may acquire the data query 112 initiated by the user 108. Then, the security limit detection module 114 of the query gateway 104 may communicate with the differential privacy online system 106, to determine whether the data query 112 meets the predetermined security limit.

At a block 204, the processing device may acquire a remaining resource associated with the user. For example, in the environment 100 shown in FIG. 1, to determine whether the data query 112 meets the predetermined security limit, the security module 124 of the differential privacy online system 106 running on the processing device 102 may acquire the remaining resource 130 associated with the user 108. In some embodiments, the remaining resource 130 associated with the user 108 may be a remaining resource allocated to the user 108. In some embodiments, the remaining resource 130 associated with the user 108 may be a remaining resource allocated to a user group to which the user 108 belongs.

At a block 206, the processing device may determine, based on the remaining resource, that the first data query meets the predetermined security limit. For example, in the environment 100 shown in FIG. 1, the security module 124 of the differential privacy online system 106 may determine, based on the remaining resource 130, whether the data query 112 meets the predetermined security limit. In some embodiments, the predetermined security limit may include whether the remaining resource associated with the user meet a predetermined resource threshold. In some embodiments, the predetermined security limit may also include whether the number of historical data queries executed by the current user that are the same as the current data query meets a predetermined count threshold.

At a block 208, the processing device may generate a second data query by modifying the first data query. For example, in the environment 100 shown in FIG. 1, after determining that the data query 112 meets the predetermined security limit, the query rewriting module 116 of the query gateway 104 may rewrite the data query 112, thereby generating the rewritten data query 118. For example, the query rewriting module 116 may perform the differential privacy algorithm on the data query 112 to generate the data query 118. In some embodiments, the query rewriting module 116 may acquire pre-determined rewriting strategies, where these rewriting strategies are determined based on a plurality of modes of aggregation query statements. For example, the aggregation query statement is a query that performs summarization and statistics on data, and may include, for example, a sum, an average value, a maximum value, and a minimum value.

At a block 210, the processing device may execute the second data query. For example, in the environment 100 shown in FIG. 1, the query execution module 120 of the query gateway 104 may execute the data query 118 (e.g., by using the query engine 110) to generate the query result 122. Then, the query result 122 may be sent to the user 108. For example, the query result 122 may be displayed to the user 108 through the user interface at the client.

Through the method, the system administrator can allocate different resources for executing data queries to different users, and only when the remaining resource associated with the user meet the predetermined security limit, the execution process of the data query may proceed. Then, the query gateway may protect security of the queried data by rewriting the data query. Therefore, the probability that the user reversely infers individual data by executing a large number of data queries can be reduced, thereby improving data security.

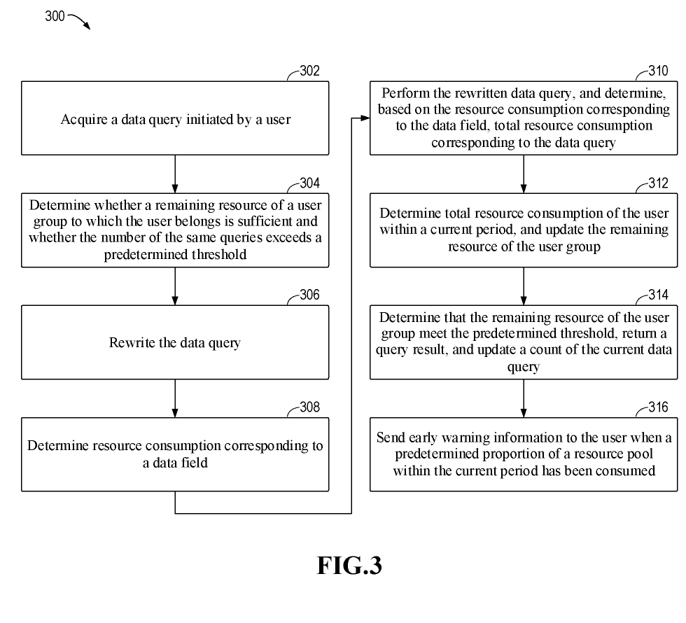

FIG. 3 illustrates a flowchart of an example process 300 for querying data according to some embodiments of the present disclosure. The process 300 may be performed by a processing device, such as the processing device 102 in FIG. 1. As shown in FIG. 3, at a block 302, the processing device may acquire a data query initiated by a user (e.g., the data query 112 in FIG. 1), where the data query may include one or more data fields. For example, the data query may be extracting a name and a department from a user table. In the example, the name and the department are two data fields. The processing device may classify the data fields into a plurality of data types, and the data type may indicate whether a data field is associated with target data. For example, when the target data is sensitive data and the user department is not the sensitive data, the department is not the data field associated with the target data. A device identifier of the user is the sensitive data, and therefore the device identifier is a data field associated with the target data.

At a block 304, the processing device may determine whether a remaining resource of a user group to which the user belongs is sufficient and whether the number of the same queries exceeds a predetermined threshold. For example, a query gateway (e.g., the query gateway in FIG. 1) may communicate with the differential privacy online system (e.g., the differential privacy online system 106 in FIG. 1), to determine whether the remaining resource of the user group to which the user belongs is sufficient and whether the number of the same queries exceeds the predetermined threshold. If the remaining resource is insufficient (e.g., the remaining resource is less than or equal to 0), or the number of the same queries initiated by the user exceeds the predetermined threshold, it indicates that the data query may be unsafe. In this case, the query gateway or the differential privacy online system may refuse the data query. If the remaining resource is sufficient and the number of the same queries initiated by the user does not exceed the predetermined threshold, it indicates that the data query is safe, and accordingly, the query gateway may allow the execution of the data query.

At a block 306, the processing device may generate a rewritten data query by rewriting the data query. The processing device may determine a data field included in the data query. Then, the processing device may determine a data type of the data field, where the data type indicates whether the data field is associated with the target data. Then, the processing device may generate noise based on the data type of the data field, and add the generated noise to the data query to generate the rewritten data query. The processing device may determine a contribution degree of a data object associated with the data field to an overall aggregation indicator and generate the noise based on the contribution degree. For example, the processing device may acquire a plurality of pre-determined user aggregation query modes and query rewriting strategies corresponding to these modes. The processing device may compute a size of the noise to be added based on a proportion of the contribution degree of the queried data object to the overall aggregation indicator (e.g., the sum and the average value).

A computing logic may be packaged in a differential privacy module to ensure the effectiveness of data protection and the standardization of computations. In the processing process, the processing device may allocate a unique user-defined function (UDF) identifier to each query field for tracking resource consumption. When the data query involves a plurality of aggregation indicator fields, the processing device may correspondingly generate a plurality of UDF identifiers and determine a corresponding amount of resource consumption based on the number of data fields. Through the method, the accuracy and controllability of resource management can be improved in multi-query scenarios. Additionally, the balance between data availability and data protection can also be improved.

At a block 308, the processing device may determine resource consumption corresponding to the data field. For example, in the UDF of ClickHouse or Spark, the system may report the resource consumed by the user query in real time, and record the consumed resource into the differential privacy online system. To efficiently store and quickly retrieve information on the resource consumption, the processing device may store the resource consumption in a memory (e.g., Redis) and convert the resource consumption of each query field into a hash structure for convenient management. The processing device may determine, based on the data type of the data field, the resource consumption corresponding to the data field. Redis is a high-performance memory-based key-value storage database that may be used for caching, session management, real-time analysis, and other scenarios. Redis may store data in the memory to increase read and write speeds. For example, data fields associated with the target data may consume more resources (e.g., 0.01), while data fields not associated with the target data may consume fewer resources (e.g., 0.005). For example, an SQL query includes a summation operation on a field A and an averaging operation on a field B, where the field A involves the sensitive data and the field B involves non-sensitive data. The processing device may determine that the resource consumption for the field A is 0.01 and the resource consumption for the field B is 0.005. Through the method, efficient storage and queries are executed through Redis, thereby monitoring the resource consumption in real time. Additionally, a resource consumption strategy is adjusted based on the data field, thereby improving the balance between data protection and data availability.

At a block 310, the processing device may perform the rewritten data query, and determine, based on the resource consumption corresponding to the data field, total resource consumption corresponding to the data query. After the query is executed, the processing device may accumulate the resource consumption recorded in Redis for the current query, thereby generating a complete resource consumption record. Then, the record may be persistently stored in a document database (e.g., MongoDB) for long-term resource tracking and management. For example, after the query is ended, the processing device may add the resource consumption of the field A (e.g., 0.01) and the resource consumption for the field B (e.g., 0.005) to obtain a total resource consumption for the current data query (e.g., 0.015). The total resource consumption is written into MongoDB to form a complete resource consumption record. The record may include, for example, a user identifier, a query identifier, a timestamp, a total resource consumption, and a plurality of pieces of resource consumption for a plurality of data fields, thereby facilitating subsequent resource analysis and management. MongoDB is a document storage-based NoSQL database that stores data in a BSON format and supports a nested document structure. The flexible data mode allows different documents to have different fields, thereby avoiding the limitations of a fixed table structure in a conventional relational database. Through the method, the complete resource consumption record may be stored in MongoDB for a long term, thereby facilitating long-term queries and analysis. Additionally, flexible indexing and querying capabilities provided by MongoDB can allow the processing device to quickly retrieve resource usage by the user.

At a block 312, the processing device may determine total resource consumption of the user within a current period, and update the remaining resource of the user group. For example, the processing device may read all resource consumption records of the current user within the current period from MongoDB, and perform summary computation on these records to obtain the total resource consumption of the user within the period. Then, the processing device may synchronously update the total resource consumption to the relational database (e.g., MySQL), to ensure that resource usage data in the database remains up-to-date. MySQL is a relational database management system that uses a structured query language for data management. In MySQL, data is stored in tables, and the tables are associated through primary keys and foreign keys, making it suitable for structured data storage. Additionally, MySQL may also provide a powerful SQL querying capability and a complex query syntax, making it suitable for data analysis and statistical computations. Through the method, using MongoDB to store resource consumption details can support persistent storage of large-scale data. Moreover, using MySQL to store the structured total resource consumption and the remaining resource for the user or the user group can improve indexing and querying speed and facilitate integration with other business systems. Additionally, periodic synchronization of the resource consumption can enhance the accuracy of resource data and ensure that the user does not excessively use an allocated resource.

At a block 314, the processing device may determine that the remaining resource of the user group meet the predetermined threshold, return a query result, and update a count of the current data query. For example, the processing device may determine the total resource consumption recorded in MySQL for the current user, to determine whether a predetermined resource upper limit is exceeded. If the total resource consumption exceeds the resource upper limit, the processing device may refuse to return the query result, thereby preventing data leakage or resource misuse. Additionally, to prevent the user from reversely inferring individual data by repeatedly submitting the same query, the processing device may format a current SQL statement, to ensure that different but equivalent SQL statements are converted into a unified standard format. Then, the processing device may perform a hash computation on the formatted SQL, thereby updating a submission count for the same query by the user, and then implementing access control for repeated queries.

At a block 316, the processing device may send early warning information to the user when a predetermined proportion of a resource pool within the current period has been consumed. For example, the current period may be a current week, and when resources consumed by an offline task reach 80% of the resource pool allocated to the current user group for the current week, the processing device may trigger an early warning mechanism and send a notification to the user, thereby reminding the user that the resources are about to be depleted. The notification may include a suggestion, such as reducing a query frequency or applying for additional resources. The notification may be sent through methods such as an email, a system notification, and a short message. Through the method, the processing device can effectively prevent resource usage from exceeding the limit while enhancing user experience, and improving controllability and sustainability of data queries.

In some embodiments, in response to determining that the remaining resource associated with the user meets a first predetermined threshold, the processing device may determine that the first data query meets the predetermined security limit. In some embodiments, the processing device may determine a number of historical data queries initiated by the user that are the same as the first data query. In response to determining that the remaining resource associated with the user meets the first predetermined threshold and the number of the historical data queries meets a second predetermined threshold, the processing device may determine that the first data query meets the predetermined security limit. In some embodiments, the remaining resource associated with the user may be remaining resource for a user group including the user.

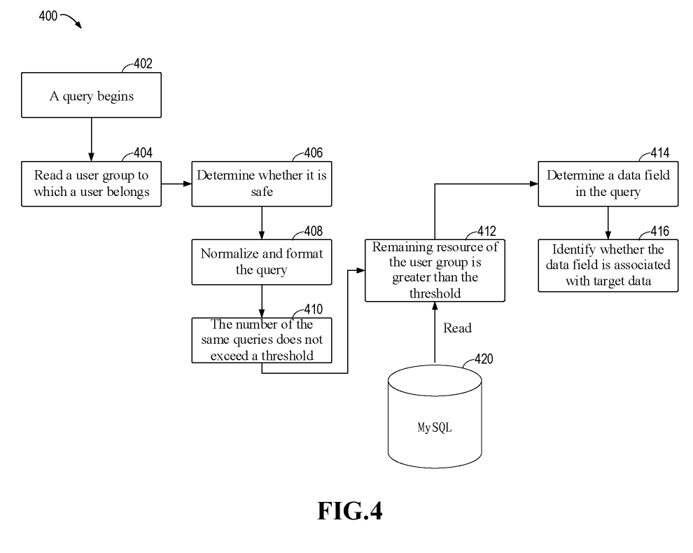

FIG. 4 illustrates a schematic diagram of an example 400 of a security module (e.g., the security module 124 in FIG. 1) of a differential privacy online system according to some embodiments of the present disclosure. As shown in FIG. 4, at a block 402, a query begins. At a block 404, the security module may read a user group to which a user initiating the query belongs. For example, the user group may be a department within an enterprise, and the user in the user group may be an employee under the department. At a block 406, the security module may determine whether the current query meets a predetermined security limit. At a block 408, the security module may normalize and format the query, such that different but equivalent query statements are converted into a unified standard format. At a block 410, the security module may determine whether the number of times the user submits the same query exceeds a predetermined threshold. If the number of the same queries has exceeded the predetermined threshold, the security module may refuse the query. If the number of the same queries does not exceed the predetermined threshold, the security module may continue to determine whether the remaining resource associated with the user exceed the predetermined threshold. At a block 412, the security module may determine whether the remaining resource of the user group to which the current user belongs is greater than the predetermined threshold. If the remaining resource of the user group is not greater than the predetermined threshold, it indicates that the remaining resource is insufficient, and the security module may refuse the query. If the remaining resource of the user group is greater than the predetermined threshold, the security module may determine that the query meets the predetermined security limit.

At a block 414, the security module may determine a data field in the query. For example, in the example show above, the security module may determine that the query includes the field A and the field B. At a block 416, the security module may identify whether the data field is associated with target data. For example, the security module may identify whether the field A and the field B are associated with the sensitive data, where the field A is associated with the sensitive data, and the field B is not associated with the sensitive data. Compared to the field B, the processing device generates more noise for the field A, and the field A will consume more resources.

Through the method, data security can be enhanced. Additionally, in multi-query scenarios, different noise can be added and different resources can be consumed for different types of data fields included in the queries, thereby improving the flexibility and accuracy of data protection.

In some embodiments, the processing device may determine total resource consumption for the first data query. The processing device may update, based on the total resource consumption, the remaining resource associated with the user. In some embodiments, the first data query includes a plurality of data fields. The plurality of data fields include a second data field. The processing device may determine a data type of the second data field. The data type indicates whether a data field is associated with the target data, and resource consumption for the second data field is determined based on the data type. Then, the processing device may determine, based on the resource consumption for the second data field, the total resource consumption for the first data query. In some embodiments, the plurality of data fields further include a third data field. In response to determining that the second data field is associated with the target data and the third data field is not associated with the target data, the processing device may allocate first resource consumption to the second data field, and allocate second resource consumption to the third data field, where the first resource consumption is greater than the second resource consumption. In some embodiments, in response to the second data query being executed and the updated remaining resource meeting a first predetermined threshold, the processing device may return a query result for the second data query to the user.

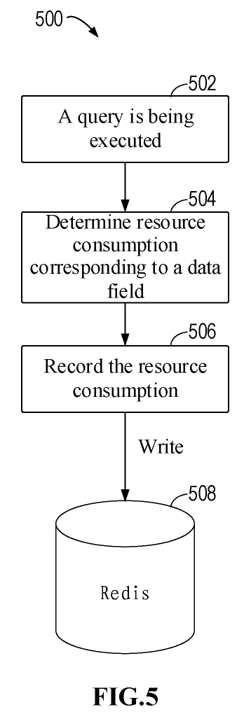

FIG. 5 illustrates a schematic diagram of an example 500 of a resource consumption determination module (e.g., the resource consumption determination module 126 in FIG. 1) of a differential privacy online system according to some embodiments of the present disclosure. As shown in FIG. 5, at a block 502, a query is being executed. At a block 504, the resource consumption determination module may determine resource consumption corresponding to a data field. The resource consumption determination module may determine a data type of the data field, where the data type indicates whether the data field is associated with target data. Then, the resource consumption determination module may determine, based on the data type, the resource consumption for the data field. At a block 506, the resource consumption determination module may record the resource consumption. The resource consumption determination module may write a plurality of pieces of resource consumption corresponding to a plurality of fields in the query into Redis 508, to quickly read the resource consumption, thereby monitoring the resource consumption.

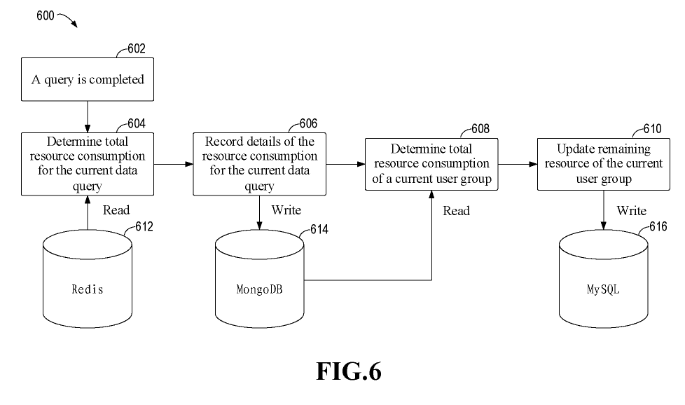

FIG. 6 illustrates a schematic diagram of an example 600 of a resource management module (e.g., the resource management module 128 in FIG. 1) of a differential privacy online system according to some embodiments of the present disclosure. As shown in FIG. 6, at a block 602, a query is completed. At a block 604, the resource management module may determine total resource consumption for the current data query. The resource management module may read a plurality of pieces of pre-stored resource consumption corresponding to a plurality of fields included in the current query from Redis 612 (e.g., Redis 508 in FIG. 5). Then, the resource management module may determine total resource consumption of the current query by accumulating the plurality of pieces of resource consumption for the plurality of fields. At a block 606, the resource management module may record details of the resource consumption for the current data query. The details may be written into MongoDB 614 for persistent storage. The details may include, for example, a query identifier, total resource consumption of a query, a field identifier (e.g., a UDF identifier), resource consumption of a field, and a timestamp.

At a block 608, the resource management module may determine total resource consumption of a current user group. The resource management module may determine a plurality of users included in the current user group, and read total resource consumption of queries initiated by these users from MongoDB. If the total resource consumption of the user group exceeds a remaining resource of the user group, the processing device may refuse to provide a query result to the users. At a block 610, the resource management module may update remaining resource of the current user group. The resource management module may write the updated remaining resource into MySQL 616 (e.g., MySQL 420 in FIG. 4), for subsequent security check of the queries.

Through the method, Redis may be used as the high-performance memory-based database to store the resource consumption records of the users in real time, thereby providing low-latency querying and updating capabilities. Additionally, using MongoDB for persistent data storage can ensure that historical resource consumption records are retained for a long term, thereby facilitating subsequent analysis and tracking. Additionally, writing the total resource consumption and the remaining resource into MySQL can ensure the stability and scalability of long-term storage, making the data more reliable in scenarios such as querying, management, and report analysis. By using a multi-tier database architecture, not only can resource changes be quickly recorded and responded to, but the security and reliability of long-term data can also be ensured, thereby improving the overall efficiency and scalability of resource management.

In some embodiments, the processing device may acquire a third data query initiated by the user. The first data query comes from a first query engine, the third data query comes from a second query engine, and the first query engine is different from the second query engine. For example, the query gateway may simultaneously receive a ClickHouse query and a Spark query. Through the method, integration with a plurality of query engines such as ClickHouse and Spark can be supported, and the resources of the users are uniformly managed across different query engines. The mechanism can ensure that regardless of which engine the user executes a query on, the system can accurately track and control the resource consumption, thereby enhancing the precision of data protection.

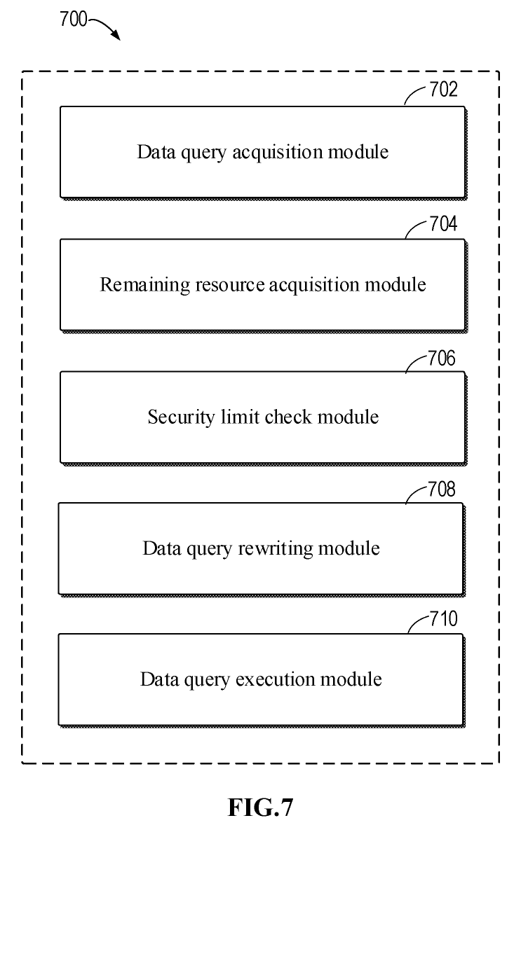

FIG. 7 illustrates a block diagram of an apparatus 700 for querying data according to some embodiments of the present disclosure. As shown in FIG. 7, the apparatus 700 includes a data query acquisition module 702, configured to acquire a first data query initiated by a user. The apparatus 700 further includes a remaining resource acquisition module 704, configured to acquire a remaining resource associated with the user. The apparatus 700 further includes a security limit check module 706, configured to determine, based on the remaining resource, that the first data query meets a predetermined security limit. The apparatus 700 further includes a data query rewriting module 708, configured to generate a second data query by modifying the first data query. Additionally, the apparatus 700 further includes a data query execution module 710, configured to execute the second data query.

In some embodiments, the security limit check module 706 includes: a resource threshold check module, configured to determine, in response to determining that the remaining resource associated with the user meets a first predetermined threshold, that the first data query meets the predetermined security limit.

In some embodiments, the resource threshold check module includes: a query count determination module, configured to determine a number of historical data queries initiated by the user that are the same as the first data query; and a query count check module, configured to determine that the first data query meets the predetermined security limit in response to determining that the remaining resource associated with the user meets the first predetermined threshold and the number of the historical data queries meets a second predetermined threshold.

In some embodiments, the remaining resource associated with the user is a remaining resource for a user group including the user.

In some embodiments, the data query rewriting module 708 includes: a data field determination module, configured to determine a first data field included in the first data query; a data type determination module, configured to determine a data type of the first data field, the data type indicates whether the data field is associated with target data; a noise generation module, configured to generate noise based on the data type of the first data field; and a noise addition module, configured to generate a second data query by adding noise to the first data query.

In some embodiments, the noise generation module includes: a contribution degree determination module, configured to determine a contribution degree of a data object associated with the first data field to an overall aggregation indicator; and a contribution degree use module, configured to generate the noise based on the contribution degree.

In some embodiments, the apparatus 700 further includes: a total resource consumption determination module, configured to determine total resource consumption for the first data query; and a total resource consumption use module, configured to update, based on the total resource consumption, the remaining resource associated with the user.

In some embodiments, the first data query includes a plurality of data fields. The plurality of data fields include a second data field. The total resource consumption determination module includes: a second data type determination module, configured to determine a data type of the second data field, the data type indicates whether a data field is associated with the target data; a data type using module, configured to determine, based on the data type, resource consumption for the second data field; and a resource consumption use module, configured to determine the total resource consumption for the first data query based on the resource consumption for the second data field.

In some embodiments, the plurality of data fields further include a third data field. The data type use module includes: a resource consumption allocation module, configured to allocate first resource consumption to the second data field, and second resource consumption to the third data field in response to determining that the second data field is associated with the target data and the third data field is not associated with the target data, where the first resource consumption is greater than the second resource consumption.

In some embodiments, the apparatus 700 further includes: a query result return module, configured to return a query result for the second data query to the user in response to determining that the second data query is executed and the updated remaining resource meeting the first predetermined threshold.

In some embodiments, the apparatus 700 further includes: a first storage module, configured to store the resource consumption for the second data field in a memory; a second storage module, configured to store the total resource consumption for the first data query in a document database; and a third storage module, configured to store the remaining resource associated with the user in a relational database.

In some embodiments, the apparatus 700 further includes: a second data query acquisition module, configured to acquire a third data query initiated by the user, where the first data query comes from a first query engine, the third data query comes from a second query engine, and the first query engine is different from the second engine.

It should be understood that by using the apparatus 700 in the present disclosure, at least one of the many advantages capable of being implemented in the method or the process described above may be achieved. For example, a system administrator can allocate different resources for executing data queries to different users, and only when the remaining resource associated with the user meet the predetermined security limit, the execution process of the data query may proceed. Then, a query gateway may protect security of the queried data by rewriting the data query. Therefore, the probability that the user reversely infers individual data by executing a large number of data queries can be reduced, thereby improving data security.

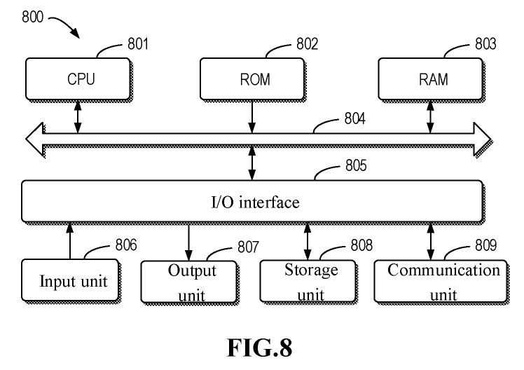

FIG. 8 illustrates a block diagram of a device 800 capable of implementing a plurality of embodiments of the present disclosure. The device 800 may be, for example, the processing device102 shown in FIG. 1. As shown in FIG. 8, the device 800 includes a central processing unit (CPU) and/or a graphics processing unit (GPU) 801, which may perform various suitable actions and processing according to computer program instructions stored in a read-only memory (ROM) 802 or computer program instructions loaded from a storage unit 808 into a random-access memory (RAM) 803. The RAM 803 may also store various programs and data required for the operation of the device 800. The CPU/GPU 801, the ROM 802, and the RAM 803 are connected to one another through a bus 804. An input/output (I/O) interface 805 is also connected to the bus 804. Although not shown in FIG. 8, the device 800 may also include a coprocessor.

A plurality of components in the device 800 are connected to the I/O interface 805, including an input unit 806 such as a keyboard and a mouse; an output unit 807 such as various types of displays and speakers; the storage unit 808 such as a disk and an optical disc; and a communication unit 809 such as a network card, a modem, and a wireless communication transceiver. The communication unit 809 allows the device 800 to exchange information/data with other devices through a computer network such as the Internet, and/or various telecommunication networks.

The various methods or processes described above may be performed by the CPU/GPU 801. For example, in some embodiments, the method may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded onto the RAM 803 and executed by the CPU/GPU 801, one or more of steps or actions of the method or the process described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, fiber optic transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., connected through the Internet with the aid of an Internet service provider).In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or another programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or improvements to technologies on the market, or to allow other persons of ordinary skill in the art to understand the various embodiments disclosed herein.

We claim:

1. A method for querying data, comprising:
acquiring a first data query initiated by a user;
acquiring a remaining resource associated with the user;
determining, based on the remaining resource, that the first data query meets a predetermined security limit;
generating a second data query by modifying the first data query; and
executing the second data query.

2. The method according to claim 1, wherein determining, based on the remaining resource, that the first data query meets the predetermined security limit comprises:
determining that the first data query meets the predetermined security limit in response to determining that the remaining resource associated with the user meets a first predetermined threshold.

3. The method according to claim 2, wherein determining that the first data query meets the predetermined security limit in response to determining that the remaining resource associated with the user meets the first preset threshold comprises:
determining a number of historical data queries initiated by the user that are the same as the first data query; and
determining that the first data query meets the predetermined security limit in response to determining that the remaining resource associated with the user meets the first predetermined threshold and the number of the historical data queries meets a second predetermined threshold.

4. The method according to claim 1, wherein the remaining resource associated with the user is a remaining resource for a user group comprising the user.

5. The method according to claim 1, wherein generating the second data query by modifying the first data query comprises:
determining a first data field comprised in the first data query;
determining a data type of the first data field, the data type indicating whether a data field is associated with target data;
generating noise based on the data type of the first data field; and
generating the second data query by adding the noise to the first data query.

6. The method according to claim 5, wherein generating the noise based on the first data field comprises:
determining a contribution degree of a data object associated with the first data field to an overall aggregation indicator; and
generating the noise based on the contribution degree.

7. The method according to claim 1, further comprising:
determining total resource consumption for the first data query; and
updating, based on the total resource consumption, the remaining resource associated with the user.

8. The method according to claim 7, wherein the first data query comprises a plurality of data fields, the plurality of data fields comprise a second data field, and determining the total resource consumption for the first data query comprises:
determining a data type of the second data field, the data type indicating whether a data field is associated with target data;
determining resource consumption for the second data query based on the data type; and
determining, based on the resource consumption for the second data field, the total resource consumption for the first data query.

9. The method according to claim 8, wherein the plurality of data fields further comprise a third data field, and determining the resource consumption for the second data query based on the data type comprises:
allocating first resource consumption to the second data field and second resource consumption to the third data field in response to determining that the second data field is associated with the target data and the third data field is not associated with the target data, wherein the first resource consumption is greater than the second resource consumption.

10. The method according to claim 7, further comprising:
returning a query result for the second data query to the user in response to the second data query being executed and the updated remaining resource meeting a first predetermined threshold.

11. The method according to claim 8, further comprising:
storing the resource consumption for the second data field in a memory;
storing the total resource consumption for the first data query in a document database; and
storing the remaining resource associated with the user in a relational database.

12. The method according to claim 1, further comprising:
acquiring a third data query initiated by the user, wherein the first data query comes from a first query engine, the third data query comes from a second query engine, and the first query engine is different from the second query engine.

13. An electronic device, comprising:
a processor; and
a memory coupled with the processor, the memory having instructions stored therein, and the instructions, when executed by the processor, causing the electronic device to:
acquire a first data query initiated by a user;
acquire a remaining resource associated with the user;
determine, based on the remaining resource, that the first data query meets a predetermined security limit;
generate a second data query by modifying the first data query; and
execute the second data query.

14. The electronic device according to claim 13, wherein the instructions causing the electronic device to determine, based on the remaining resource, that the first data query meets the predetermined security limit further cause the electronic device to:
determine that the first data query meets the predetermined security limit in response to determining that the remaining resource associated with the user meets a first predetermined threshold.

15. The electronic device according to claim 14, wherein the instructions causing the electronic device to determine that the first data query meets the predetermined security limit in response to determining that the remaining resource associated with the user meets the first preset threshold further cause the electronic device to:
determine a number of historical data queries initiated by the user that are the same as the first data query; and
determine that the first data query meets the predetermined security limit in response to determining that the remaining resource associated with the user meets the first predetermined threshold and the number of the historical data queries meets a second predetermined threshold.

16. The electronic device according to claim 13, wherein the remaining resource associated with the user is a remaining resource for a user group comprising the user.

17. The electronic device according to claim 13, wherein the instructions causing the electronic device to generate the second data query by modifying the first data query further cause the electronic device to:
determine a first data field comprised in the first data query;
determine a data type of the first data field, the data type indicating whether a data field is associated with target data;
generate noise based on the data type of the first data field; and
generate the second data query by adding the noise to the first data query.

18. The electronic device according to claim 17, wherein the instructions causing the electronic device to generate the noise based on the first data field further cause the electronic device to:
determine a contribution degree of a data object associated with the first data field to an overall aggregation indicator; and
generate the noise based on the contribution degree.

19. The electronic device according to claim 13, wherein the instructions further cause the electronic device to:
determine total resource consumption for the first data query; and
update, based on the total resource consumption, the remaining resource associated with the user.

20. A computer program product, wherein the computer program product is tangibly stored on a non-transitory computer-readable medium and comprises machine-executable instructions, and the machine-executable instructions, when executed, cause a machine to:
acquire a first data query initiated by a user;
acquire a remaining resource associated with the user;
determine, based on the remaining resource, that the first data query meets a predetermined security limit;
generate a second data query by modifying the first data query; and
execute the second data query.
